(19) United States
(12) Patent Application Publication
(10) Pub. No.: US 2010/0317277 A1
(43) Pub. Date: Dec. 16, 2010

(54) AIR OUTLET

(75) Inventors: Thorsten Raible, Hamburg (DE); Ruediger Heske, Buxtehude (DE); Dirk Baxmann, Hamburg (DE); Enrico Chelli, Buxtehude (DE); Ingo Gores, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Operations GmbH, Hamburg (DE)

(21) Appl. No.: 12/761,574

(22) Filed: Apr. 16, 2010

Related U.S. Application Data
(60) Provisional application No. 61/170,165, filed on Apr. 17, 2009.

(30) Foreign Application Priority Data
Apr. 17, 2009 (DE) 10 2009 017 911.9

(51) Int. Cl. B60H 1/24; F24F 13/08

(52) U.S. Cl. 454/162; 454/339

(57) ABSTRACT

An air outlet has at least one air supply line and at least one baffle plate, wherein the opening cross section of the air supply line is arranged in a plane running parallel to the baffle plate, the baffle plate has a circumferential contour, and is spaced apart from the air supply line, and the opening cross section of one end of the air supply line is directed toward the baffle plate. Such air outlets are particularly suited for small-volume rest rooms, such as in a vehicle, which require a sufficiently high ventilation quality at the lowest possible draught.

### CROSS-REFERENCE TO RELATED APPLICATIONS

This application claims the benefit of the filing date of U.S. Provisional Patent Application No. 61/170,165 filed Apr. 17, 2009, the disclosure of which application is hereby incorporated herein by reference.

### BACKGROUND OF THE INVENTION

The invention relates to an air outlet, the use of an air outlet in a rest room, as well as a vehicle with at least one rest room and at least one air outlet arranged therein.

Vehicle cabins, which are also referred to below as “passenger cabins,” often utilize air conditioning systems to create a cozy climate for passengers, which introduce suitably processed air through air outlets into the passenger cabin. Prior art has a plurality of different air outlet forms intended to enable as uniform an introduction of processed air as possible.

Passenger cabins sometimes also have special areas that require a maximum level of coziness and comfort. Such areas are to create a private and relaxed atmosphere for an individual passenger or vehicle attendants in a relatively small volume of space, such as in so-called “super first class suites” or in rest rooms for vehicle attendants, which are also known as “crew rest compartments.” These individual areas are more or less separate from the rest of the passenger cabin, and often require a separate air supply and corresponding air distributor within the separated air volume. Special emphasis is here placed on the absence of drafts accompanied by good ventilation quality, so that the correspondingly high demands on thermal comfort can be satisfied.

Widely used in prior art for ventilating such high-comfort areas are air outlets with lateral slits, in which the incoming air is introduced in the form of highly pulsed and only slightly fanned, bundled air jets from a ceiling or a side of a room. This generates a tangential, cylindrical flow with a relatively high throw range or penetration depth. A pronounced flow impulse is required for generating the cylindrical flow, so that a desired air induction and mixing is provided. However, this pronounced flow impulse simultaneously results in uncomfortable drafts, and hence diminishes the individually perceived comfort, as manifested in the relatively high flow rate at the air outlets as well as downstream from them. Drafts are more pronounced in cases where there are no dissipating boundary conditions that slow the flow rate in the core jet of a cylindrical flow, which are partially achieved by means of curtains with free opening cross sections on a side of the curtain lying opposite an air inlet.

The high outlay involved in making adjustments to the respective application combined with the slight installation area available makes the assembly and manufacture of such air outlets complicated, and hence cost intensive, since baffles, perforated plates, injection moldings, metal components and the like must be individually adjusted to the respective application. In like manner, slight changes in the boundary conditions inside the sealed volume of the high-comfort area to be ventilated can also lead to a distinct change in ventilation quality.

U.S. Pat. No. 6,056,239 shows rest room arrangements in an airplane with compact, lateral air outlets that are equipped with directional flaps for adjusting an exiting jet of air.

### BRIEF SUMMARY OF THE INVENTION

The air outlets used in prior art can be perceived as disadvantageous with respect to ventilation comfort in a small-volume rest room. This holds true in particular when the rest room volume is characterized by a low ceiling height and rigid walls on the longitudinal sides.

The object of the invention is to propose an air outlet that provides as draft-free a ventilation of a small-volume, sealed rest room at low flow rates. Another object of the invention could be to integrate such an air outlet in the contours of the volume in such a way that the air outlet cannot necessarily be identified as one.

An air outlet according to the invention has at least one air inlet line and at least one baffle plate. The opening cross section of the air supply line is preferably arranged in a plane running parallel to the baffle plate. The baffle plate further has a circumferential contour, and is spaced apart relative to the air supply line. In addition, the opening cross section of one end of the air supply line is directed toward the baffle plate.

Therefore, this air outlet represents a so-called radial diffuser, in which air coming from one or more air supply lines hits the baffle plate, and as a result streams out again from a gap between the baffle plate and aforementioned plane. As a result, the air is guided in a radial direction and its flow rate diminishes as the outlet cross section between the baffle plate and opening cross section increases. This depends on the distance between the baffle plate and the plane or slit width, as well as on the spatial expansion of the baffle plate. The flat or slightly inclined jets generate a diffuse, sparingly directed, spatial cylindrical flow in the room volume to be ventilated. The high degree of turbulence in the flow here produces a less bundled and more widely fanned jet, and helps reduce the flow rates relative to jet air outlets after shorter distances. As a consequence, the thermal comfort is tangibly increased, and the air outlet according to the invention is simultaneously robust relative to configuration changes in the room volume to be ventilated, since the air is guided out over a larger surface area. In addition, this air outlet type is expected to be less sensitive relative to changes in the inflow conditions, like a larger incoming stream of air.

The proposed air outlet according to the invention can be used in particular anywhere that a certain amount of air is to be introduced in a small room volume in simultaneous proximity to a person in the room volume and the air outlet according to the invention. The air rates in direct proximity to a person are low, and can be less than 0.2 m/s or so as the target, for example, which would also correspond to DIN 1946. Thermal comfort is increased. Such an air outlet is easy to assemble, and the component complexity is low, since the air outlet according to the invention is essentially based on a deflection or baffle plate that receives a transverse flow. In addition, the air outlet according to the invention can have a very low weight, in particular if the baffle plate is made out of a light material, such as a reinforced fiber plastic with a honeycomb structure or “crashed”/compressed honeycomb structure in the core. The air flows homogeneously out of an air outlet according to the invention, and has relatively uniform flow rates at the opening cross section of the air outlet.

The inflow of air is uniform, diffuse, very turbulent and without any defined core jet. The dissipation rate of kinetic energy is high, so that the inlet rates can be broken down more rapidly. Also achieved is an improved, homogeneous air mixture in the prescribed volume, without a defined cylindrical convection with relatively high core rates. In addition, the air outlet according to the invention has a relatively low volume, thus leaving behind larger residual volume of the room to be ventilated. This holds true in particular in cases where a conventional jet air outlet would have to be clad, as in the case of cots or beds inside the room volume. Finally, three is great flexibility in integrating the air outlet, since the air passage can be adjusted to the ceiling or lateral wall contour, so that the air passage traces the shape of bordering walls, and can be used as a style element.

In a particularly advantageous embodiment of the present invention, the area between the baffle plate and plane in an area between the air outlet and circumferential contour of the baffle plate accommodates at least one calibration element with at least one through opening with a predetermined flow behavior. The air flowing out of the air supply lines and hitting the baffle plate is forced by the radially acting deflector to the circumferential area of the baffle plate, and flows through the calibration element in the process. The through openings can here be dimensioned in such a way as to have a predetermined flow resistance at each circumferential point of the air outlet according to the invention, and hence a resultant flow rate of the outgoing air. If a calibration element must always be traversed to achieve any point of the circumferential contour, the flow rates can be calibrated to desired levels along the entire circumferential contour.

For example, a calibration element could be designed as a perforated sheet, in which flow resistances can be selected by adjusting the opening diameter. A higher flow resistance results from smaller through openings, while a lower flow resistance results from larger through openings.

In like manner, the at least one calibration element can be designed by means of a cross sectional constriction between the baffle plate and the plane. Attaching moldings that suitably reduce the cross section a, for example at the edge of the baffle plate, makes it possible to individually configure the distance between the baffle plate and plane at each point on the periphery to form a continuous flow rate profile.

In this conjunction, it must be classified as especially advantageous to form several sequentially arranged calibration elements between the baffle plate and the plane, which in their entirety form a closed circumference for creating a flow rate profile.

Also proposed is a rest room in a passenger cabin of a vehicle, which has at least one accommodation unit for a person and at least one previously described air outlet for ventilating the rest room. A rest room could be a mini-suite in a super first class of a passenger cabin of an airplane, a rest room for flight attendants (also called “crew rest compartment”), or a sleeper compartment in a train or the like. These rest rooms are usually highly restricted in terms of their volume, so that high flow rates can be avoided when using an air outlet according to the invention, while still provide a high ventilation quality.

Let it be noted at this juncture that special advantages can be achieved by using the calibration elements described above on the air outlet according to the invention precisely in a rest room of a vehicle. In a very compact rest room, the distance between a passenger and the air outlet according to the invention per se is relatively slight. If the accommodation unit for the passenger is a cot, it would be conceivable to calibrate the air outlet according to the invention in such a way that the air to be discharged is routed out disproportionately stronger toward the torso and feet of the passenger, while the outgoing amount of air is correspondingly reduced in the head area of the passenger. This makes it possible to avoid a situation in which the passenger reacts sensitively to air flowing toward the face, while at the same time keeping the ventilation quality of the rest room fully intact. This calibration can be performed via the calibration elements, so that the opening cross section in a circumferential area directed toward the head of the passenger is dimensioned to be smaller than the through holes directed toward the foot end of a bunk. If necessary, it is also conceivable to completely seal a certain circumferential cross section of the baffle plate to achieve this effect.

It is especially advantageous for the at least one baffle plate of the at least one air outlet to be realized in the form of a suspended rest room ceiling, creating a harmonious optical appearance, while at the same time keeping the additional weight resulting from the air outlet according to the invention relatively low, even given baffle plates with very large dimensions.

Finally proposed is the use of an air outlet and a vehicle with at least one rest room and at least one air outlet arranged in the at least one rest room with the aforementioned features.

### BRIEF DESCRIPTION OF THE DRAWINGS

Additional features, advantages and possible applications of the present invention may be gleaned from the following description of the exemplary embodiments and figures. In this case, all described and/or graphically depicted features constitute the object of the invention whether taken individually or in any combination, even regardless of their composition in the individual claims and their back references. Further, the same references numbers in the figure represent identical or similar objects.

FIG. 1 shows a lateral section of a first exemplary embodiment of an air outlet according to the invention.

FIG. 2 shows a lateral section of a second exemplary embodiment of an air outlet according to the invention.

FIG. 3 shows a lateral section of another exemplary embodiment of the air outlet according to the invention.

FIG. 4 shows a lateral section of another exemplary embodiment of the air outlet according to the invention.

FIG. 5 shows a lateral section of another exemplary embodiment of the air outlet according to the invention.

FIG. 6 shows an arrangement of two rest rooms, each with one exemplary embodiment of an air outlet according to the invention.

FIG. 7 shows an arrangement of two rest rooms, each with another exemplary embodiment of an air outlet according to the invention.

FIG. 8 shows a rest room in the form of a mini-suite with an exemplary embodiment of an air outlet according to the invention.

FIG. 9 shows an airplane with at least one rest room and an air outlet arranged therein.

### DETAILED DESCRIPTION

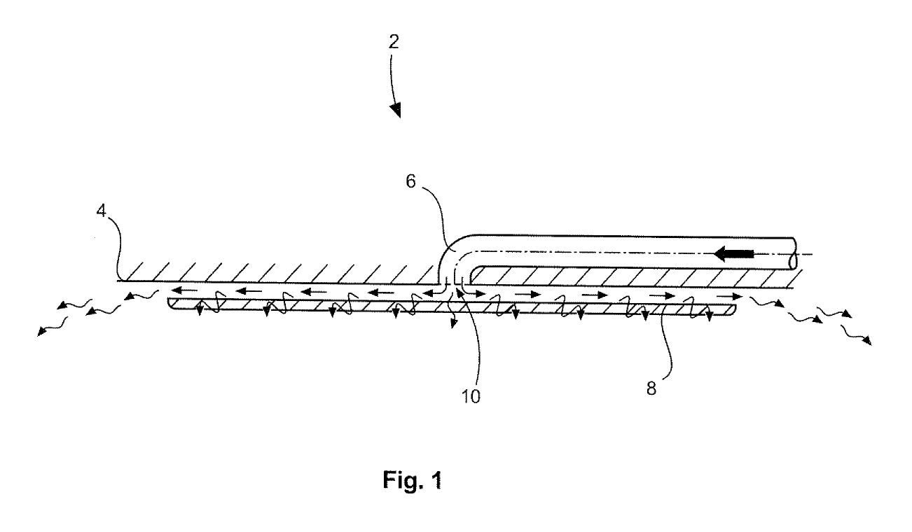

An air outlet 2 from FIG. 1 has a plane 4, for example realized as a cabin ceiling or room ceiling. An air supply line 6 that carries air empties into this plane 4. Spaced apart form the plane 4 is a baffle plate 8, which in the case shown runs parallel to the plane 4. The air supply line 6 has an opening cross section 10 directed toward the baffle plate 8. As a consequence, the air flowing out of the air supply line 6 hits the baffle plate 8, and is then radially deflected, and flows into the room to be ventilated in a planar direction from the gap between the baffle plate 8 and plane 4. Depending on how the baffle plate 8 is dimensioned, this leads to a drop in the air flow rate, and more diffuse air flows come about in the room.

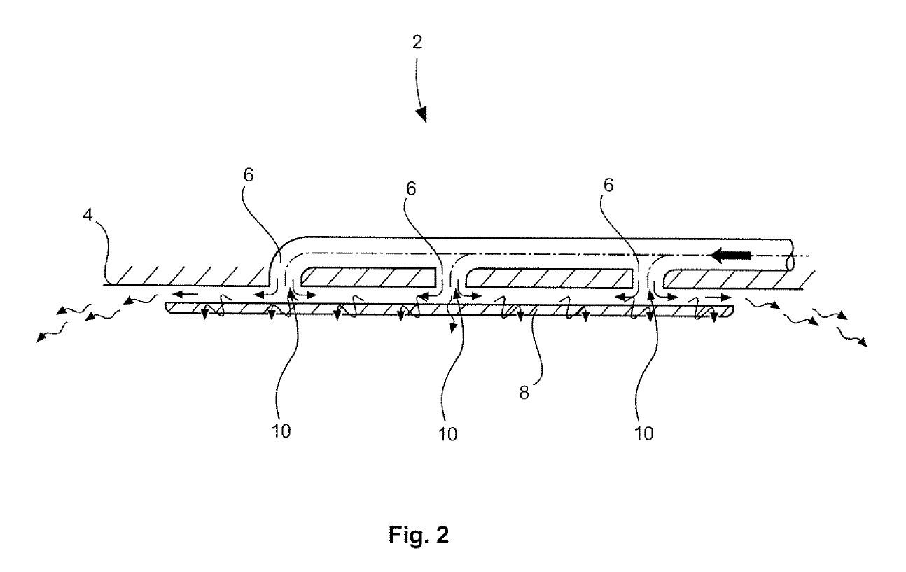

FIG. 2 shows a modification of the air outlet 2 from FIG. 1, which incorporates several air supply lines 6, which each have an opening cross section 10 directed toward the baffle plate 8. Here as well, air flows into the gap between the baffle plate 8 and plane 4, so that the air is deflected in its direction of flow, and streams radially out of the gap between the baffle plate 8 and plane 4.

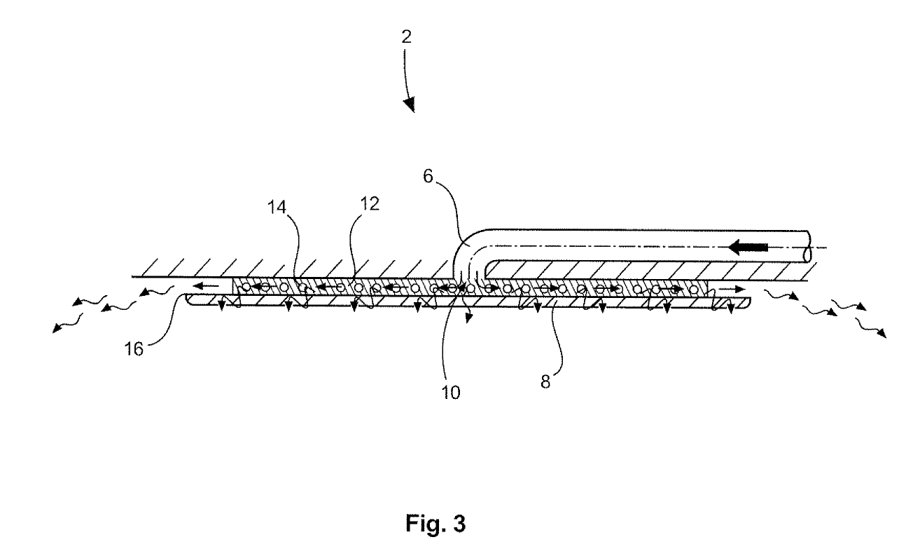

FIG. 3 shows another modification of the air outlet 2, in which the gap between the baffle plate 8 and plane 4 incorporates one or more calibration elements 12, which each have through openings 14, through which the air can flow. The calibration elements 12 are preferably arranged between a circumferential contour 16 of the baffle plate 8 and the air supply line 6, so that outwardly flowing air must pass through the calibration element.

Depending on how the through openings 14 are dimensioned, a more or less high flow resistance can be provided for the outgoing air, so that the flow rate of outgoing air from the gap of the baffle plate 8 and plane 4 can be set locally at all points of the circumferential contour 16 of the baffle plate 8.

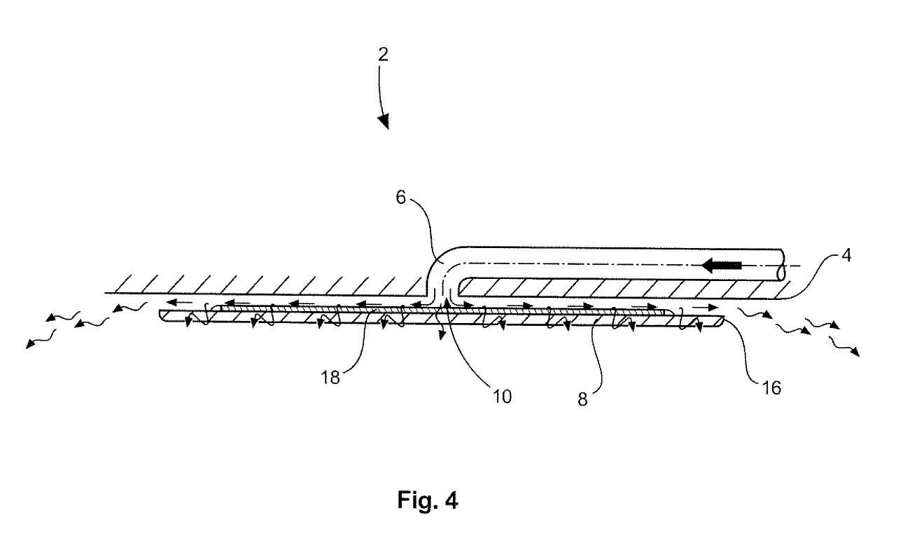

FIG. 4 shows another modification of the air outlet 2 according to the invention, in which calibration elements 18 are arranged in the gap between the baffle plate 8 and plane 4, and here are realized in the form of elevations or cross sectional constrictions/bulges. The local constriction of the distance between the baffle plate 8 and plane 4 also makes it possible to set the flow rate along the entire circumferential contour. As described in the introduction to the specification, this makes it possible to introduce less air in the facial area of reclined passengers than at the foot end of their cot.

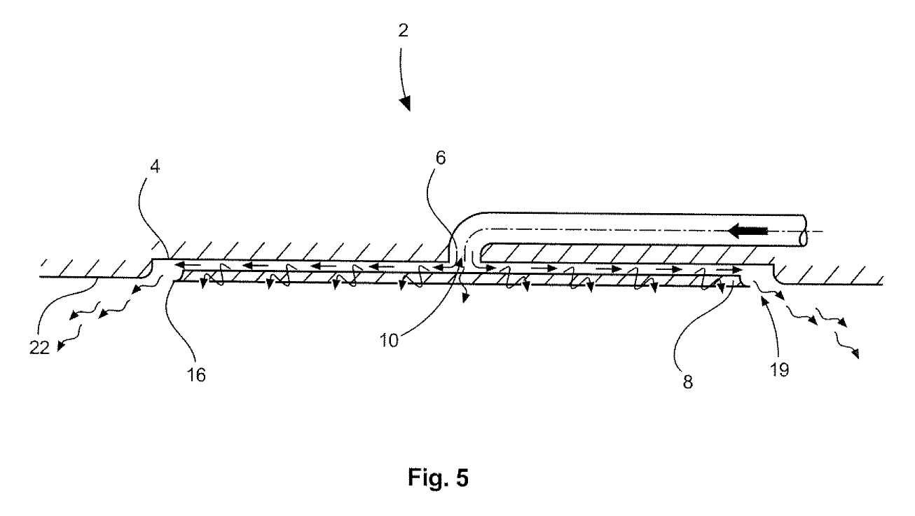

The additional exemplary embodiment from FIG. 5 shows that the plane can be recessed in a rest room ceiling 22 in such a way that the baffle plate 4 can be arranged at the same height as the room ceiling 22. The gap between the plane and baffle plate necessary for the radial outflow is completely recessed in the rest room ceiling 22, wherein the air can flow out of a continuous recess 19 into the rest room. The circumferential contour 16 of the baffle plate 8 can be rounded, sharpened or otherwise adjusted to influence the outflow direction and noise development.

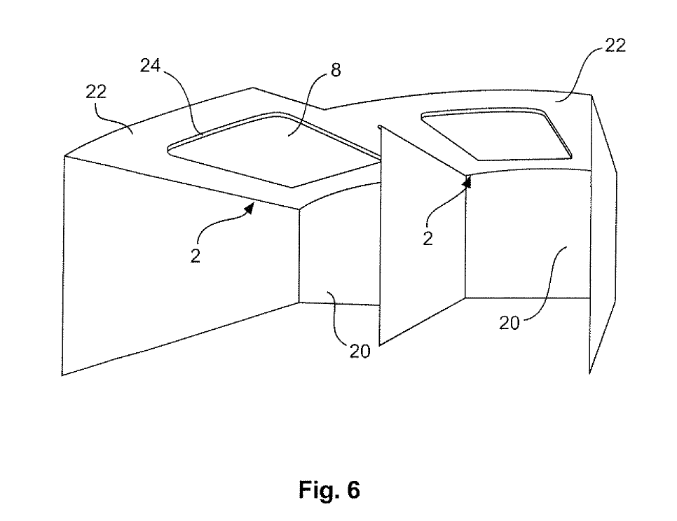

FIG. 6 graphically illustrates two rest rooms 20, in which accommodation units for passengers or flight attendants or the like can be arranged. The ceiling of the respective rest room 20 has an air outlet 2 according to the invention, in which the baffle plate 8 in the case depicted is realized as a suspended ceiling element. The rest room ceiling 22 and baffle plate 8 define a gap 24 from which air can flow out. This gap 24 can incorporate calibration elements that set the flow rates of the outgoing air in each area of the respective rest room 20.

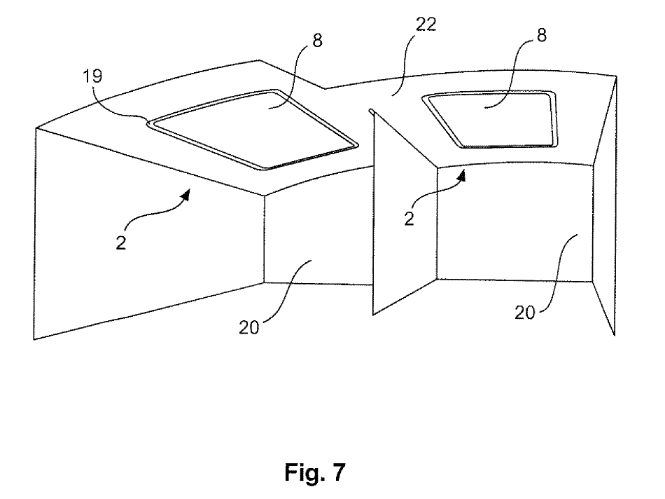

FIG. 7 shows a modification of the rest rooms 20 from FIG. 6, which have the air outlets 2 with a baffle plate integrated in the rest room ceiling 22. The respective recess 19 from which air can flow out and into the respective rest room 20 runs between the baffle plate 8 and cabin ceiling 22.

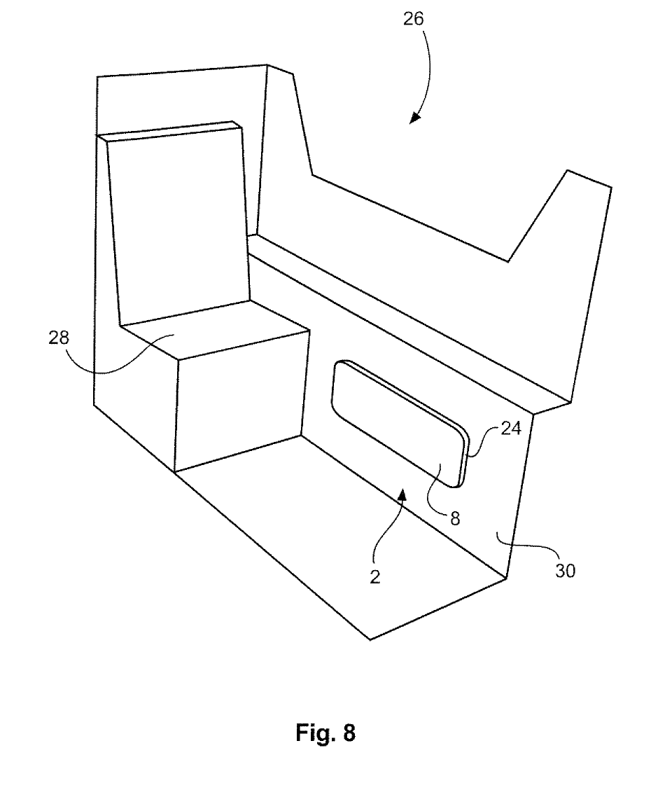

FIG. 8 presents a diagrammatic view of a separated cabin area 26, which has an accommodation unit 28 in the form of a passenger seat that converts into a cot, and is also occasionally referred to as “super first class suite”. Given the rather small room volume and high comfort requirement, it makes sense to integrate an air outlet 2 according to the invention in a lateral wall 30 of such a cabin area 26, so that sufficient ventilation can be realized while simultaneously minimizing drafts.

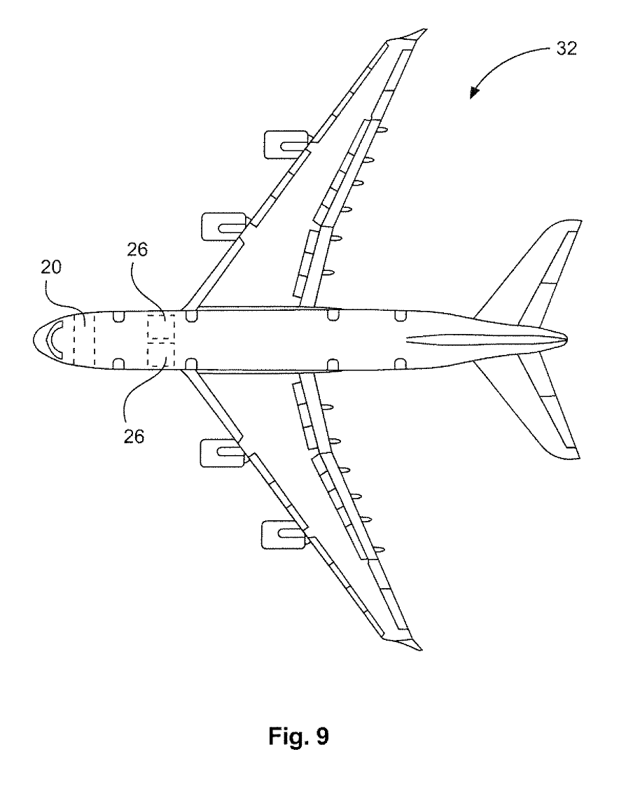

Finally, FIG. 9 presents an example of an airplane equipped with a passenger cabin, which has at least one rest room 20 and/or at least one separated cabin area 26. The rest room 20 could be designed as a rest room for flight attendants or crewmembers, and the separated cabin area 26 as a super-first-class mini-suite.

An air outlet according to the invention is especially suitable for small-volume rest rooms, for example in a vehicle that requires a sufficiently high ventilation quality at the lowest possible draught. The flat design approach with a baffle plate makes it possible to realize an optically harmonious and space-saving integration into ceiling or wall surfaces of rest rooms.

### REFERENCE NUMBERS

2 Air outlet
4 Plane
6 Air supply line
8 Baffle plate
10 Opening cross section
12 Calibration element
14 Through opening
16 Circumferential contour
18 Calibration element
19 Recess
20 Rest room
22 Cabin ceiling
24 Gap
26 Separated cabin area
28 Accommodation unit
30 Lateral wall
32 Airplane

1. An air outlet, comprising:
at least one air supply line; and
at least one baffle plate;
wherein an opening cross section of one end of the at least one air supply line is arranged in a plane running parallel to the at least one baffle plate;
wherein the at least one baffle plate has a circumferential contour and is spaced apart from the at least one air supply line;
wherein the opening cross section of one end of the at least one air supply line is directed toward the baffle plate; and
wherein the at least one baffle plate is adapted for deflecting an air flow exiting the at least one air supply line into a direction parallel to the at least one baffle plate and for radially guiding to the circumferential contour in a gap between the plane and the at least one baffle plate.

2. The air outlet of claim 1, wherein at least one calibration element with at least one through opening having predetermined flow characteristics is arranged in the gap between the at least one baffle plate and the plane in an area between the at least one air supply line and the circumferential contour of the at least one baffle plate.

3. The air outlet of claim 2, wherein the at least one calibration element is a perforated sheet.

4. The air outlet of claim 2, wherein the at least one calibration element is designed as a cross sectional constriction between the at least one baffle plate and the plane.

5. The air outlet of claim 2, wherein the at least one calibration element is arranged between the at least one baffle plate and the plane, and forms a closed circumference.

6. The air outlet of claim 2, wherein flow resistance coefficients of the at least one calibration element are adjusted in such a way that the resulting flow rates of outgoing air are set to predetermined levels along the circumferential contour of the air outlet.

7. The air outlet of claim 2, wherein the at least one baffle plate is arranged at the same height as a rest room ceiling, and a recess for discharging air is formed between the at least one baffle plate and the rest room ceiling.

8. A rest room in a passenger cabin of a vehicle, comprising: at least one accommodation unit for a person and at least one air outlet of claim 1 for ventilating the rest room.

9. The rest room of claim 8, wherein the at least one baffle plate of the at least one air outlet is a suspended rest room ceiling.

10. A vehicle having at least one rest room and at least one air outlet arranged in the at least one rest room, comprising:
at least one air supply line; and
at least one baffle plate;
wherein an opening cross section of one end of the at least one air supply line is arranged in a plane running parallel to the baffle plate,
wherein the at least one baffle plate has a circumferential contour and is spaced apart from the at least one air supply line,
wherein the opening cross section of one end of the air supply line is directed toward the at least one baffle plate; and
wherein the at least one baffle plate is adapted for deflecting an air flow exiting the air supply line into a direction parallel to the at least one baffle plate and for radially guiding to the circumferential contour in a gap between the plane and the at least one baffle plate.
